(19) United States
(12) Patent Application Publication
(10) Pub. No.: US 2009/0106364 A1
(43) Pub. Date: Apr. 23, 2009

(54) Method and apparatus for peer-to-peer network traffic analysis

(75) Inventor: Jukka Rissanen, Espoo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/907,780

(22) Filed: Oct. 17, 2007

(51) Int. Cl. G06F 15/16

(52) U.S. Cl. 709/205

(57) ABSTRACT

A method and an apparatus can be provided for identifying and separately treating peer-to-peer traffic in a network. For example, the method can include identifying a supernode of a peer-to-peer network using intelligent heuristics. The method can also include identifying additional nodes of the peer-to-peer network using feedback. The method can further include marking the supernode and additional nodes as peer-to-peer nodes in a list. In certain embodiments, the method can additionally include updating the list using an intelligent update.

### CROSS REFERENCE TO RELATED APPLICATIONS:

The present application is related to and claims the priority of Provisional U.S. Patent Application No. 60/661,447, filed Nov. 29, 2006, the entirety of which is hereby incorporated by reference.

### BACKGROUND OF THE INVENTION

1. Field of the Invention

The invention generally relates to network traffic analysis to the discovery of peer-to-peer (P2P) network connections from a number of existing network connections. P2P network traffic is known to cause congestion in certain computer networks. Identification and handling of such traffic in mobile networks such as General Packet Radio Service (GPRS) can be helpful in maximizing efficiency of network resources.

2. Description of the Related Art

Network connections in computer networks such as Transmission Control Protocol/Internet Protocol (TCP/IP) networks are typically identified by a 5-tuple, such as network protocol used, source address, source port, destination address, and destination port. These five characteristics or 5-tuple can be sufficient to uniquely identify the network connection. In performing network traffic analysis, these five settings can be identified and handled in various ways. For example, Hypertext Transport Protocol (HTTP) traffic is identified as protocol=TCP/IP, destination port 80, and other settings in the 5-tuple can vary. Thus, it can be seen that, if two settings of the 5-tuple are known, then the type of traffic can be identified and classified. The content of the traffic, in terms of bytes of data in the flow, can also be used to identify the applicable protocol, but traffic can sometimes be encrypted. Such encryption can make it difficult to learn the type of data being transferred, and therefore complicate network analysis.

### SUMMARY OF THE INVENTION

One embodiment of the present invention can be a method. The method can include identifying peer-to-peer connection patterns. The method can also include marking traffic identified by the patterns as peer-to-peer traffic. The method can further include identifying a destination address of the traffic as a peer-to-peer host. The method can additionally include marking the peer-to-peer host as a supernode. The method can also include treating network connections to the supernode as peer-to-peer network connections. In certain embodiments, the method can further include identifying peer-to-peer nodes that are no longer receiving peer-to-peer traffic and, once a node is identified that does not receive peer-to-peer traffic, terminating treating the node as a peer-to-peer client.

Another embodiment of the present application can be an apparatus. The apparatus can include a first identifying unit configured to identify peer-to-peer traffic based upon connection patterns. The apparatus can also include a marking unit configured to mark the traffic as peer-to-peer traffic. The apparatus can further include a hosting unit configured to specify a destination host of the traffic as a peer-to-peer host, and to mark the host as a supernode, wherein the hosting unit is configured to treat all traffic to the supernode and all network connections to the supernode as peer-to-peer network connections. It should be noted that, as used in the present application, the “hosting unit” employs the term “hosting” not because the unit hosts (engages in an act of hosting something), but because the unit can, for example, classify a node as a host. In certain embodiments, the apparatus can further include a second identifying unit configured to identify a peer-to-peer designated node that is no longer receiving peer-to-peer traffic, and to remove the designation of the node as a peer-to-peer client.

A further embodiment of the present invention is another method. This method can include identifying a supernode of a peer-to-peer network using intelligent heuristics. The method can also include identifying additional nodes of the peer-to-peer network using feedback. The method can further include marking the supernode and additional nodes as peer-to-peer nodes in a list. In certain embodiments, the method can additionally include updating the list using an intelligent update.

An additional embodiment of the present invention is another apparatus. The apparatus can include a first identifying unit configured to identify a supernode of a peer-to-peer network using intelligent heuristics. The apparatus can also include a second identifying unit configured to identify additional nodes of the peer-to-peer network using feedback. The apparatus can further include a marking unit configured to mark the supernode and additional nodes as peer-to-peer nodes in a list. In certain embodiments, the apparatus can additionally include updating the list using an intelligent update.

Yet another embodiment of the present invention can be a computer program tangibly embodied on a computer readable medium encoding instructions for performing various functions. The computer program can include instructions for identifying a supernode of a peer-to-peer network using intelligent heuristics. The computer program can also include instructions for identifying additional nodes of the peer-to-peer network using feedback. The computer program can further include instructions for marking the supernode and additional nodes as peer-to-peer nodes in a list. In certain embodiments, the computer program can additionally include instructions for updating the list using an intelligent update.

An additional embodiment of the present invention can be yet another apparatus. The apparatus can include identifying means for identifying a supernode of a peer-to-peer network using intelligent heuristics and for identifying additional nodes of the peer-to-peer network using feedback. The apparatus can also include marking means for marking the supernode and additional nodes as peer-to-peer nodes in a list. In certain embodiments of the present invention, the apparatus can further include updating means for updating the list using an intelligent update.

### BRIEF DESCRIPTION OF THE DRAWINGS

For proper understanding of the invention, reference should be made to the accompanying drawings, wherein:

FIG. 1 illustrates a flow chart according to an embodiment of the invention;

FIG. 2 is a general illustration of a P2P network, in which a plurality of nodes can have virtual direct connections to each other through a hub or a switch;

FIG. 3 illustrates a block diagram of an apparatus that is configured to implement the invention; and

FIG. 4 is a flow chart illustrating another embodiment of the invention.

### DETAILED DESCRIPTION OF THE PREFERRED EMBODIMENT(S):

An example method according to the present invention can be one that performs network analysis to identify P2P traffic, and block, charge, or otherwise perform specific handling of the P2P traffic to maximize efficient use of valuable network resources.

In P2P networks such as, for example, Skype™, traffic is encrypted and there is no central server to which P2P clients connect on a continual basis. Such configurations can make it difficult to identify the 5-tuple that identifies the utilization of P2P protocol. Some P2P networks can treat certain P2P nodes as special; for example, if a node has an enough network capacity, then P2P traffic can, in some cases, be routed through this node. Such a node is typically called a supernode due to its carrying, or capacity for carrying a large amount of data and/or traffic.

In network traffic analysis methods and systems, identification of supernodes can be helpful in order to simplify handling of traffic. Often, a significant amount and sometimes all traffic to and from a supernode is P2P traffic. Thus, often all connections to and from a supernode are P2P connections.

Certain embodiments of the present invention can identify the P2P 5-tuple in network traffic analysis using intelligent heuristics with feedback. For example, a P2P client, which can be referred to as node A, can be identified by the fact that it creates a significant number of connections to other peers within a short window of time, which can in many cases be less then 1 second.

Certain methods and systems according to the invention can identify this connection pattern, and mark the traffic as P2P traffic. Certain embodiments of the invention can identify, for example, two characteristics in the 5-tuple, the protocol and source address. Consequently, the network connection can be classified as P2P traffic. This stage of the analysis can be referred to as the intelligent heuristics phase.

When the 5-tuple has been found, then the destination host or other peer, which can be (for convenience) referred to as node B, in the P2P network can be treated as a potential P2P host/client. If there are numerous connections to node B then node B can also be marked as a supernode, and network connections to it can all be treated as P2P network connections. This stage of the analysis can be referred to as the feedback phase.

Certain embodiments of the present invention can also identify P2P nodes that are no longer receiving P2P traffic. In many cases, computer networks can use dynamic Internet Protocol (IP) address assignment. In other words, the IP address of a host or client can change over time. Certain embodiments of the invention can identify that an existing P2P client/host, for example, node A, has not received any P2P data or traffic for some time. Such embodiments of the invention, therefore, would stop treating node A as a P2P client. This can be referred to as the intelligent update phase of the analysis.

Thus, certain embodiments of the present invention can identify P2P 5-tuple information from network traffic using intelligent heuristics, feedback, and intelligent updates. Such identification can enable P2P network traffic classification, and enable the treatment of P2P traffic in a manner that is different from other network traffic.

Such embodiments can help significantly increase efficient use of network resources, and potentially avoid exhausting valuable network resources. Existing network analysis methods and systems are not capable of identifying and analyzing P2P network traffic in a manner that is favorably comparable to embodiments of the present invention.

Some methods and apparatuses according to embodiments of the invention, therefore, are capable of detecting that a node initiates at least a predetermined number of connections to other nodes within a predetermined time, and classifying such initiating nodes as P2P nodes and/or obtaining P2P 5-tuples. Certain embodiments of the invention can also detect whether the nodes so connected have more than a predetermined number of connections to further nodes.

Certain embodiments of the present invention can then classify such nodes as P2P nodes. The predetermined time window for identifying whether a predetermined number of connections are being made can be, for example, one second, and the predetermined number of connections can be, for example, five connections during this one second period of time. Certain embodiments of the invention would enable such parameters to be configurable.

Various embodiments of the present invention can be implemented in numerous types of networks and systems, including computer networks having a number of P2P nodes disposed therein, and cellular/IP Multimedia Subsystem (IMS) networks where cellular or mobile user equipment communicates through base stations or directly, in which user terminals can be or include nodes and/or base stations can be or include nodes.

Particular embodiments of the present invention can also be implemented as computer software embodied on a computer readable medium, with the software being able to run on a processor, and controlling the processor to perform the steps of, for example, the methods that are discussed above. Such software can also cause a processor to be configured as the various hardware elements discussed herein.

More particularly, certain embodiments of the present invention may, for example, be embodied as traffic analyzer and/or firewall computer hardware, computer software, or a hybrid thereof. Thus, certain embodiments of the present invention can be implemented, for example, on a general purpose computer or an Application Specific Integrated Circuit (ASIC).

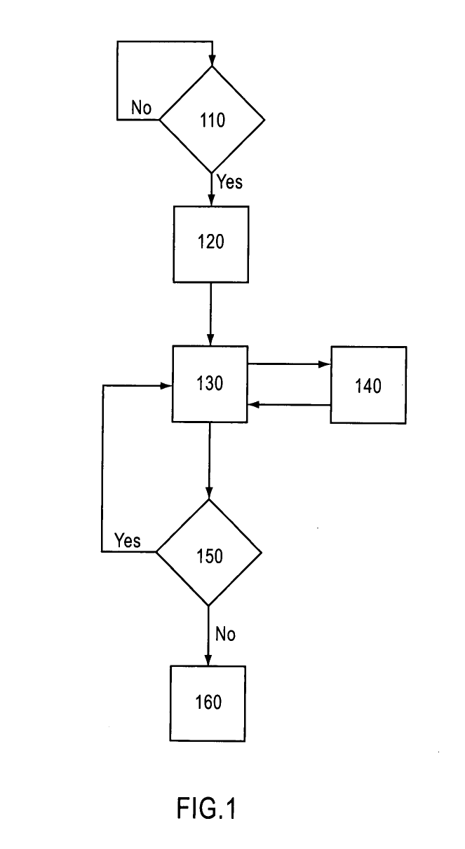

FIG. 1 illustrates a flow chart according to an embodiment of the invention. According to FIG. 1, a check 110 is made to see if a P2P client initiates a predetermined number of connections in a given time period. If the answer is yes, the initiating node is identified 120 as a P2P node. Then a check 130 is made to determine whether other nodes connected to the initiating nodes have a sufficient volume of connections over a given period of time. If yes (e.g. if they do have a volume sufficient to trigger an inference that they are supernodes), these other nodes are classified 140 as P2P nodes.

The embodiment illustrated in FIG. 1, and various other embodiments of the invention, can then monitor 150 traffic to a P2P node, to determine whether P2P traffic is still being transmitted with respect to the node. If no P2P traffic is received for a predetermined period of time, then the node is no longer treated 160 as a P2P node.

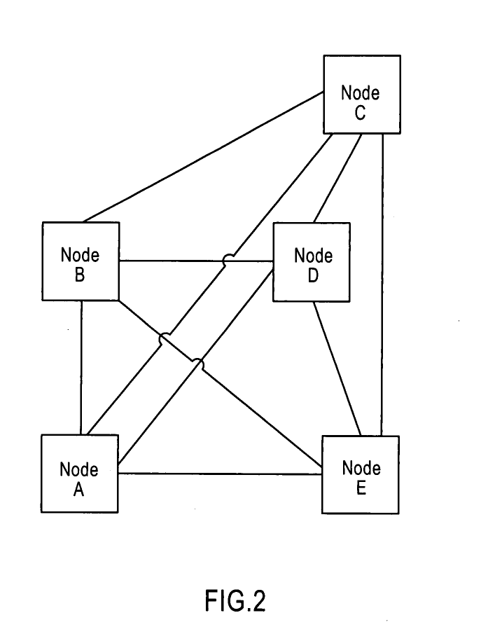

FIG. 2 is a general illustration of a P2P network, in which a plurality of nodes can have virtual direct connections to each other through a hub or a switch (the hub or switch is not shown). Such a network can be distinguishable from a client-server network, in which all nodes of a network are logically connected to a common file server for file services.

For example, in one popular embodiment of a P2P network, nodes share files directly with one another rather than uploading the files to a central file server for subsequent retrieval. The nodes of FIG. 2, as mentioned previously, can include various types of user equipment including cellular telephones, base stations, computers, laptop computers, stationary computers, and the like.

Thus, for example, Node A, Node B, Node C, Node D, and Node E can, for example, be mobile communication devices that are capable of communicating with each other via, for example a mobile switching center (MSC), a base station (BS), or similar technology. Alternative, the nodes can be nodes of a LAN connected by a single router or switch in a physical star topology. There is no requirement that all of the nodes be part of the same physical network.

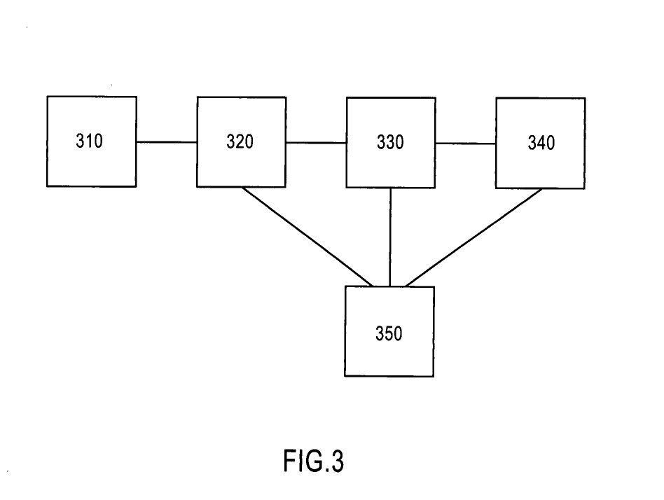

FIG. 3 illustrates a block diagram of an apparatus that is configured to implement the invention. The apparatus can include an initiating unit 310 that monitors initiated connections by client node. An identifying unit 320 can identify the initiating node as a P2P node, and a marking unit 330 can mark the traffic as P2P traffic.

The identifying unit 320 can rely on various indicia of P2P traffic, such as the number of connections generated within a particular time frame. Other techniques for distinguishing P2P traffic from, for example, ordinary web browsing HTTP traffic can also be used. These units can perform the intelligent heuristics phase of the analysis.

Another identifying unit 340 can then identify other P2P nodes based upon the number of connections to the other P2P nodes meeting specific criteria and refer back to the marking unit 330 to mark the other P2P nodes. These units can perform the feedback phase of the analysis. A de-classifying unit 350 can monitor P2P traffic to nodes that have been identified as P2P nodes, and can remove the P2P designations from P2P nodes that are no longer receiving P2P traffic.

The de-classifying unit 350 can cooperate with the identifying unit 320, the marking unit 330, and the other identifying unit 340 to perform its operations. These units can perform the intelligent update phase of the analysis.

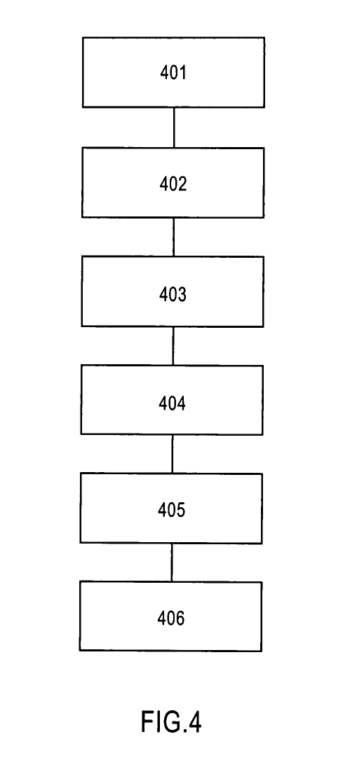

FIG. 4 is a flow chart illustrating another embodiment of the invention. According to FIG. 4, at 401 a P2P client creates a predetermined number of connections in a given amount of time. At 402, traffic from the P2P client is marked as P2P traffic. At 403, using protocol and source address, which are two items of the 5-tuple, a connection is classified as a P2P connection.

At 404, as shown in FIG. 4, a destination host can be identified based on the 5-tuple. If the connection volume meets predetermined criteria regarding connection volume over a period of time, the destination host is classified as a P2P host or a supernode, at 405.

At 406, P2P nodes are de-classified into non-P2P nodes when P2P traffic falls below a predetermined threshold, or falls to zero. The process illustrated in FIG. 4 can be performed repeatedly, and the steps described should not necessarily be viewed as having to be performed in the order illustrated simply because they are illustrated in that order.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
identifying peer-to-peer connection patterns;
marking traffic identified by the patterns as peer-to-peer traffic;
identifying a destination address of the traffic as a peer-to-peer host;
marking the peer-to-peer host as a supernode; and
treating network connections to the supernode as peer-to-peer network connections.

2. The method of claim 1, further comprising:
identifying peer-to-peer nodes that are no longer receiving peer-to-peer traffic; and
once a node is identified that does not receive peer-to-peer traffic, terminating treating the node as a peer-to-peer client.

3. An apparatus, comprising:
a first identifying unit configured to identify peer-to-peer traffic based upon connection patterns;
a marking unit configured to mark the traffic as peer-to-peer traffic;
a hosting unit configured to specify a destination host of the traffic as a peer-to-peer host, and to mark the host as a supernode, wherein the hosting unit is configured to treat all traffic to the supernode and all network connections to the supernode as peer-to-peer network connections.

4. The apparatus of claim 3, further comprising:
a second identifying unit configured to identify a peer-to-peer designated node that is no longer receiving peer-to-peer traffic, and to remove the designation of the node as a peer-to-peer client.

5. A method, comprising:
identifying a supernode of a peer-to-peer network using intelligent heuristics;
identifying additional nodes of the peer-to-peer network using feedback; and
marking the supernode and additional nodes as peer-to-peer nodes in a list.

6. The method of claim 5, further comprising:
updating the list using an intelligent update.

7. The method of claim 6, wherein the updating the list comprises removing nodes from the list when the nodes no longer engage in peer-to-peer network traffic.

8. The method of claim 5, wherein the identifying the supernode comprises identifying at least two characteristics of the supernode's 5-tuple.

9. The method of claim 8, wherein the at least two characteristics comprise protocol and source address.

10. The method of claim 5, wherein the identifying the supernode comprises identifying that the supernode encounters a number of connections greater than a predetermined threshold within a predetermined amount of time.

11. The method of claim 10, wherein the predetermined amount of time is approximately 1 second, and wherein the predetermined threshold is approximately five.

12. The method of claim 5, wherein the identifying the other nodes comprises identifying nodes that are in communication with the supernode.

13. The method of claim 5, further comprising:
blocking communication with nodes on the list, based on the list.

14. The method of claim 5, further comprising:
applying charges or fees to nodes on the list, based on the list.

15. The method of claim 5, wherein the marking the supernode and the additional nodes comprises specifically distinguishing between ordinary nodes and supernodes.

16. An apparatus, comprising:
a first identifying unit configured to identify a supernode of a peer-to-peer network using intelligent heuristics;
a second identifying unit configured to identify additional nodes of the peer-to-peer network using feedback; and
a marking unit configured to mark the supernode and additional nodes as peer-to-peer nodes in a list.

17. The apparatus of claim 16, further comprising:
updating the list using an intelligent update.

18. The apparatus of claim 17, wherein the updating the list comprises removing nodes from the list when the nodes no longer engage in peer-to-peer network traffic.

19. The apparatus of claim 16, wherein the marking the supernode and the additional nodes comprises specifically distinguishing between ordinary nodes and supernodes.

20. The apparatus of claim 16, wherein the identifying the supernode comprises identifying at least two characteristics of the supernode's 5-tuple.

21. The apparatus of claim 20, wherein the at least two characteristics comprise protocol and source address.

22. The apparatus of claim 16, wherein the identifying the supernode comprises identifying that the supernode encounters a number of connections greater than a predetermined threshold within a predetermined amount of time.

23. The apparatus of claim 22, wherein the predetermined amount of time is approximately 1 second, and wherein the predetermined threshold is approximately five.

24. The apparatus of claim 16, wherein the identifying the other nodes comprises identifying nodes that are in communication with the supernode.

25. The apparatus of claim 16, further comprising:
blocking communication with nodes on the list, based on the list.

26. The apparatus of claim 16, further comprising:
applying charges or fees to nodes on the list, based on the list.

27. A computer program tangibly embodied on a computer readable medium encoding instructions for performing:
identifying a supernode of a peer-to-peer network using intelligent heuristics;
identifying additional nodes of the peer-to-peer network using feedback; and
marking the supernode and additional nodes as peer-to-peer nodes in a list.

28. The computer program of claim 27, further comprising instructions for performing:
updating the list using an intelligent update.

29. An apparatus, comprising:
identifying means for identifying a supernode of a peer-to-peer network using intelligent heuristics and for identifying additional nodes of the peer-to-peer network using feedback; and
marking means for marking the supernode and additional nodes as peer-to-peer nodes in a list.

30. The apparatus of claim 29, further comprising:
updating means for updating the list using an intelligent update.
